(19) United States
(12) Patent Application Publication
(10) Pub. No.: US 2012/0303435 A1
(43) Pub. Date: Nov. 29, 2012

(54) Method and System for Promoting Social Loyalty Through a Social Network Based Platform

(75) Inventors: Shivani Rawat, Karapakkam (IN); Phanindra BalaSri Meduri, Karapakkam (IN)

(73) Assignee: TATA CONSULTANCY SERVICES LIMITED, Maharashtra (IN)

(21) Appl. No.: 13/480,600

(22) Filed: May 25, 2012

(30) Foreign Application Priority Data
May 26, 2011 (IN) 2011/MUM/2011

(51) Int. Cl. G06Q 30/02

(52) U.S. Cl. 705/14.27

(57) ABSTRACT

The present invention provides a system and method of facilitating enhanced customer engagement by integrating multiple channels, particularly social networking platform for interaction with the retailer. The invention utilizes the concept of social coupons to encourage customer's participation in brand promotion by way of incentivizing the customer for interacting with the retailer and also for disseminating the social coupon via social networking platform. The invention thus facilitates enhanced customer visit to the retail touch points on a periodic basis.

### FIELD OF INVENTION

The present invention relates generally to the retail domain, more particularly to a system and method that is integrated with a social network platform, to promote loyalty.

### BACKGROUND OF INVENTION

The advent of global communication channels such as interne and other modes of user interaction and collaboration have precipitated socialization virtually on any domain of interest. Retailing, for example, is experiencing multidimensional expansion by involving these principal forms of communication. While brick and mortar ways of transaction paved way into virtual space, concepts such as loyalty, assortment optimization seek new waters with statistical and scientific methods. Discounting, a mere mechanism to attract customers is now a prime subject for any retailer.

Retailers are exploring all channels to connect to prospects and customers to make loyalty programs ubiquitous. Marketing channels and mediums through which the retailers access the customer touch points increasingly shows a variation. These modern channels now pave way to interact with customer in ways never explored before.

In recent years Web sales continue to outpace comparable-store sales and the trend is accelerating as for 42 of 65 leading department stores, specialty apparel, general merchandise and other chain retailers, the growth online in recent years has exceeded the increase in annual comparable-store sales. Mobile-based sales continue to grow as 0.2 billion users have accessed retail app/site.

Discussed below are some figures which reflect user engagement with socially networked channels. For example, social platform Facebook bested Web giants Google, Yahoo and Microsoft in time spent online by the user in recent times. As reported, users spent 12.7% of their time in recent past and the logged in time has been reported to 49.4bn minutes. Further, the number of page viewer's statistics is shown to be 76.8bn minutes.

According to comScore Inc. 9/10 U.S Internet users visited social network at least once a month in 2011. Social networking accounts for one of six minutes spent online, with Facebook alone accounting for 15% of all time spent online and roughly 16% of page views. These figures suggest the tendency of users to engage with retailers on social network is more than any other channel. Hence, it is important to have a loyalty application integrated with social network platform to enhance customer engagement, and enable periodic interaction with consumers post transaction.

While people spend over 700 bn minutes per month on social platforms such as Facebook, 50% of the active users log on to Facebook in any given day indicating the frequency of visits. Also, average user has 130 social contacts which is hitherto the case on any other hosted platforms. This is a good chance for a retailer to increase the reach of the promotions.

Comprehensive loyalty solutions have emerged to manage activities such as enrollment to targeting; configure rewards for purchases and activities; multiple customer rewards and efficient customer communication across channels. However, most of the solutions fail to achieve the following objectives.

Firstly, the customer does not interact with a retailer on a periodic basis. Loyalty/gift card with online accounts to manage customers have become a must-have or a definite differentiating feature. Most of these programs only incentivize customers on their purchase with programs such as time-based redemption, bundled promotions etc. to encourage repeated purchase. Retailers are participating actively to push content while proactive customer involvement is loosely coupled.

Most of the Interaction Initiatives are in the form of time-based promotions. Although, they drive traffic from one channel to another for once, they don't encourage sustainable flow.

Secondly, channels equipped with entire functionalities tend to work in silos. Most of these applications have functionality to reflect activities done on one platform such as online, mobile, in-store across others. In this regard, integrated customer engagement is not viewed and monitored as a whole across multiple channels and modes. The motive behind providing a single personalized portal for customer engagement across multiple channels is to enable customers to use a preferred channel according to convenience. A single functionality across different channels is modified to suit the channel best, however eventually are the mirror images. Though retailers have started initiatives which drive customer from one channel to another, this movement is majorly one way. Multiple channels, for example, mobile, e-commerce, store, social networking platform like Facebook have become increasingly popular and enormously powerful way to interact, share information and virally spread information about brands, products, ideas, and people.

Retailers have been successful in implementing most functionalities across various channels in order to provide multi-channel engagement to customers. However, the effort to push the traffic across channels remains unaccomplished.

Thirdly, social media has been identified as yet another powerful channel for communicating information, but is underplayed with limited functionality such as catalogue promotion, “like” feature, broadcast information, etc. Rather than being a stand-alone channel, social media can be leveraged to act along with other channels. It can act as an effective driver across channels.

The next step identified towards customer engagement is to prompt the customer to interact with various retailer touch points and interplay in a periodic manner. Businesses should connect the dots of current store technologies with customers' social media platforms for promoting sales.

In light of the foregoing, incentive award programs have been initiated to promote customer loyalty by way of increasing repeated business with the same retailer in exchange of reward points for the customer with each transaction/interaction.

One problem that emerges while managing activities associated with providing comprehensive loyalty solutions and ensuring efficient customer communication channels is that there is no means that can engage customers and encourage sustainable flow across different channels. Though retailers have been successful in implementing most of their functionalities in providing multi-channel engagement to customers, the effort to push traffic across channels remains unaccomplished.

It has therefore become important to engage customers to interact with various touch points and interplay in a periodic manner and establish presence across different channels. This invites need for an incentive based mechanism that rewards consumers upon purchase of products from a particular retailer and simultaneously encourages the consumer to drive the promotional themselves.

### OBJECT OF THE INVENTION

In accordance with the present invention a system and method of implementing a loyalty program on social media to enhance customer engagement is provided.

It is an object of the present invention to integrate social media platforms with a customer's interaction with a retailer.

One of the objects of the present invention is to drive traffic at offline or web stores, or any other transaction channel by utilizing collaborative features of social networking channels.

Yet another object of the present invention is to leverage existing social connections of customers' social network by providing a social network based loyalty platform from a particular retailer.

Still another object of the present invention is to encourage customer promoted spread of loyalty on a social network by sharing social coupons.

Yet another object of the present invention is to convert accumulated loyalty points to customer's credit maintained on social platform for trade promotion.

It is another object of the present invention to provide event based promotional features and ability to exchange loyalty points among customers and their social connections.

### SUMMARY OF INVENTION

The present invention relates to a method and system of promoting customer interaction with a retailer by using collaborative features of a socially networked platform. The system leverages a customer's social relationship within a social network by rewarding the customer with a social coupon which can be shared in a social network. The customer is further rewarded additional points whenever the social coupon is downloaded and consumed by entities of a social network, thereby increasing the number of prospects for a retailer.

The invention enables a first participating user to access his or her loyalty account to check for social coupons credited by the retailer. The user can display the coupon and further share it in a plurality of social network for promotion. The user is credited loyalty points in a loyalty account if entities of a social network utilize the social coupon. The mechanism, thus rewards the first participating user upon each download of the coupon irrespective of any purchase made by entities of a social network and thus triggers sales either by interaction or transaction.

The system broadly comprises an interaction aggregator responsible for tracking activities over a social network platform, a processing engine to issue reward points for every interaction, a promotion engine to process and deliver promotions or coupons based on a set of predefined rules thereby facilitating for sharing and enabling users to download coupons for redemption, an enrollment module to update the number of added network entities and also record the number of networked entities confirmed as users of the loyalty application.

### BRIEF DESCRIPTION OF THE DRAWINGS

The foregoing summary, as well as the following detailed description of preferred embodiments, are better understood when read in conjunction with the appended drawings. For the purpose of illustrating the invention, there is shown in the drawings example constructions of the invention; however, the invention is not limited to the specific methods and system disclosed. In the drawings:

FIG. 1 illustrates a functional diagram for implementing a social loyalty module to enhance customer engagement.

FIG. 2a and FIG. 2b illustrates the flow of social coupon management.

FIG. 2c represents the flow of social coupon as availed by the social contact of the loyalty member who downloads the social coupon.

FIG. 3 illustrates the system for implementing a loyalty application that is integrated with a social network platform.

### DETAILED DESCRIPTION OF THE INVENTION

Some embodiments of this invention, illustrating all its features, will now be discussed in detail.

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present invention, the preferred, systems and methods are now described.

Described in detail below are a system and a method for promoting customer interaction with a retailer, which may comprise visit to a physical store, web stores, a kiosk, mobile store or any other mode as known in the art to be integrated with one or more social network-based platforms. The terms social network-based platform, social channels and social network may be used interchangeably. Social network-based platforms include, but are not limited to social networks, such as Facebook, MySpace, Friendster, Bebo, Orkut, Hi5, and Ning.

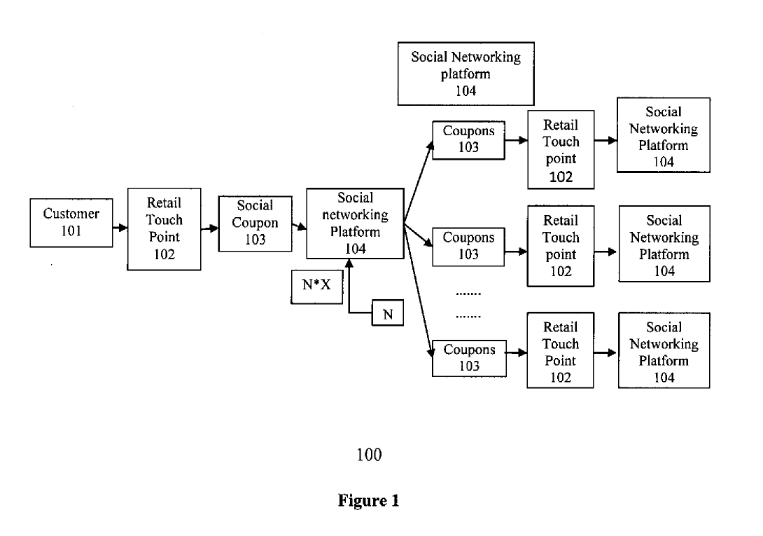

FIG. 1 illustrates the functional diagram 100 for implementing social loyalty module to enhance customer engagement. The system 100 includes plurality of customers 101, purchase stores or other retail touch points 102, social coupon 103 and social networking platform 104. A retail outlet credits a customer 101 with loyalty coupons in their loyalty account based on a purchase made, said loyalty accounts are maintained on a social networking platform 104. Social coupons accrued to the customer 101 are maintained in a personalized portal hosted within a social networking platform. Customers 101 can access a plurality of such coupons stored in the personalized portal after due authentication procedures known in the art. Social coupons thus awarded to customers by a retail outlet are hosted in a customer's social network 104, thus making the coupon visible to all entities that are socially relevant to the customer. Social behavior of the coupon 103 is exhibited when the customer shares the coupon on the social network. Once the customer agrees to share the coupon, said coupon is made available to all of the customer's social contacts in a social network. Thus, the coupon awarded can be utilized by customers and their social contacts. Further, through this method, the customer 101 will be rewarded points if the coupon shared is utilized by their social contacts for interactions or transactions with a retailer that awarded the coupons.

In one embodiment, this ‘Social coupon’ 103, can optionally be availed by a limited number (N) of the users who download the coupon first. Thus, the first few social contacts of the customer who download the coupon can utilize the coupon sponsored by the retailer for any purchase within a specified time limit or as per any other condition imposed by the retailer. Customer 101 will be credited with points or any other benefit for every coupon 103 downloaded by a social contact. The scheme of continually rewarding the customer for every engagement with the retailer or in his social network with respect to brand interaction fosters periodicity in the whole cycle of transaction as the customer remains ever enthusiastic to make periodic interaction with the retailer on regular basis, irrespective of any seasonal promotional campaigns or festive discount initiatives by the retailer. At this stage it is important to know that although social contacts can download and use a coupon, they cannot post it on their social networking accounts until they become member of the loyalty program of the retailer.

According to one of the embodiments, a first participating user gains reward points for every instance of social coupon being downloaded by social contacts. Thus rewarding a first user is not limited to interaction or transaction of the social contacts with a retailer but for promotion of the retailer. Following are various scenarios where a first participating user 101 is rewarded.

Scenario 1: Shared social coupon 103 is downloaded by first N social contacts.

Scenario 2: Downloaded social coupons 103 are utilized by social contacts that interact or transact with said retailer.

Scenario 3: Completion of any task or activity (including non-transactional and not restricted to purchase) that the retailer creates in association with said awarded coupon.

The present invention provides a unique way for the customer 101 to share coupons 103 with little participation or promotion from the retailer. The social platform can result in an exponential increase of promotional activities and creates increased visibility for a retailer. The social coupon 103 awarded to customers, has the potential to attract prospective customers, drive sales, and increase loyalty base.

A retailer can enroll social contacts of a customer into a Loyalty application after said social contacts avail the social coupons by way of download. This can probably increase loyalty and traffic to stores or retail touch points (mobile store, online store, mobile app, kiosk and the like) 102 and additionally, increase personalized promotions and future relationship among loyalty members.

Apart from sharing coupons, some tasks can be designed for the customers. The tasks can be defined by a retailer as either an online task on the personalized portal or can include purchase of some specific items from the retails store. By creating such tasks the customer is more engaged with the retails store. By this, the customer 101 would not only get coupons, but is also rewarded with additional points for sharing the coupons and further more for completion of said tasks. For the retailer, this introduces a new concept of making a prospect/customer engage with the retailer on a periodic basis.

An exemplary reward mechanism based on a loyalty module is another unique feature of the present invention. Say for example, during a promotional event such as a festival season, the ‘Social coupon’ 103 can comprise a secret code which in turn comprises rewards according to the volume or value of purchase. When a first participating user shares the ‘Social coupon’ 103 on the social network, an icon indicating a special activity or message, for instance a special gift appears on the Loyalty account. The user 101 may have to purchase a specific category of products within a certain time limit, or fulfill any conditions that are relevant to the awarded social coupon. On meeting the conditions, the icon would unlock to reveal the special gift.

When the task is being completed by the first user, the customer's social contacts would get to know about the special gift through social updates and they might also want to avail the special festival coupon. This activity can be introduced on customer portals and deployed using predefined rules and can be customized to categories, keeping in mind the retailer's profitability.

According to one embodiment of the invention, the social platform 104 offers retailers access to a customer's social contacts. Hence, many activities can be driven by the customer 101 that involve social behavior. As an exemplary feature, a retailer's loyalty application can facilitate in schemes such as exchange of loyalty points between two members. Such a feature on the loyalty portal enables increase in sales and offering rewards to members. Loyalty members can transfer points between themselves based on a wish list of products that one may want to purchase.

Majority of social network users play social games and 40% of all the time spent in social gaming. In another embodiment of the invention, point conversion feature can target the social garners. An embodiment of the invention enables a customer to convert a certain percentage of points accumulated while playing a game into credit points after making a purchase at the store 102 thus targeting the social garners. In another embodiment feature of social gaming can be introduced with a concept of social coupons. A participating user can be awarded multiple coupons based on demographic attributes such as age, gender, personalization. As soon as a primary participating user logins to the social platform that is integrated with a retailer loyalty account, the user is awarded a plurality of coupons. That can be shared. Said coupons may have set criteria, such as time based action, which a social contact may consume within the criteria imposed.

In one preferred embodiment, a user is authenticated using a one-time authentication process. The authentication process would seek user's confirmation regarding access to personal details such as a contact list, User ID and the like. This authentication takes place through an encryption mechanism that is known in the art and returns a handle that can be used to retrieve important information on connections (Friends, activities, location etc.). Access tokens for the connections can be used to retrieve information.

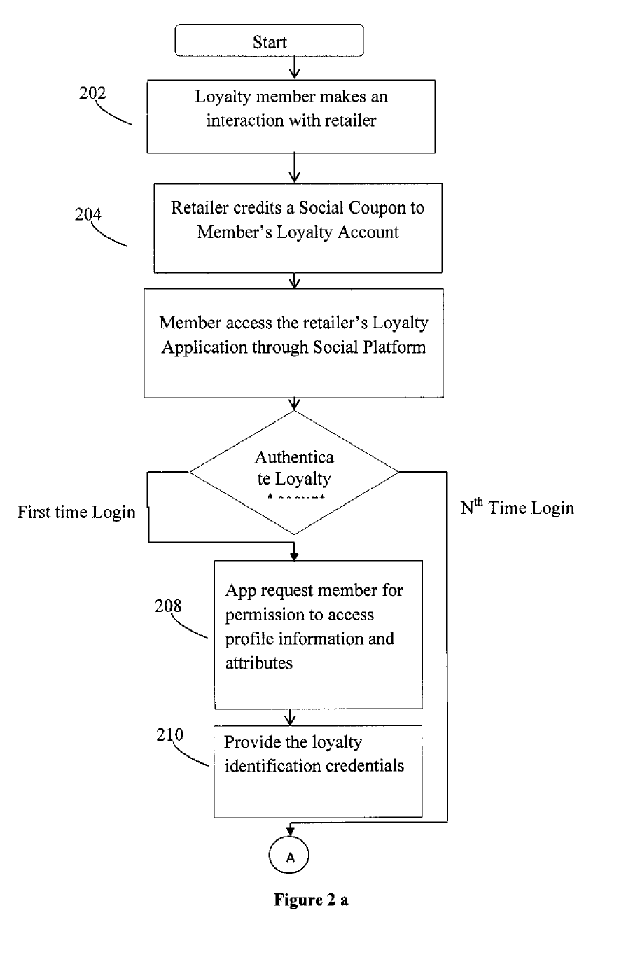

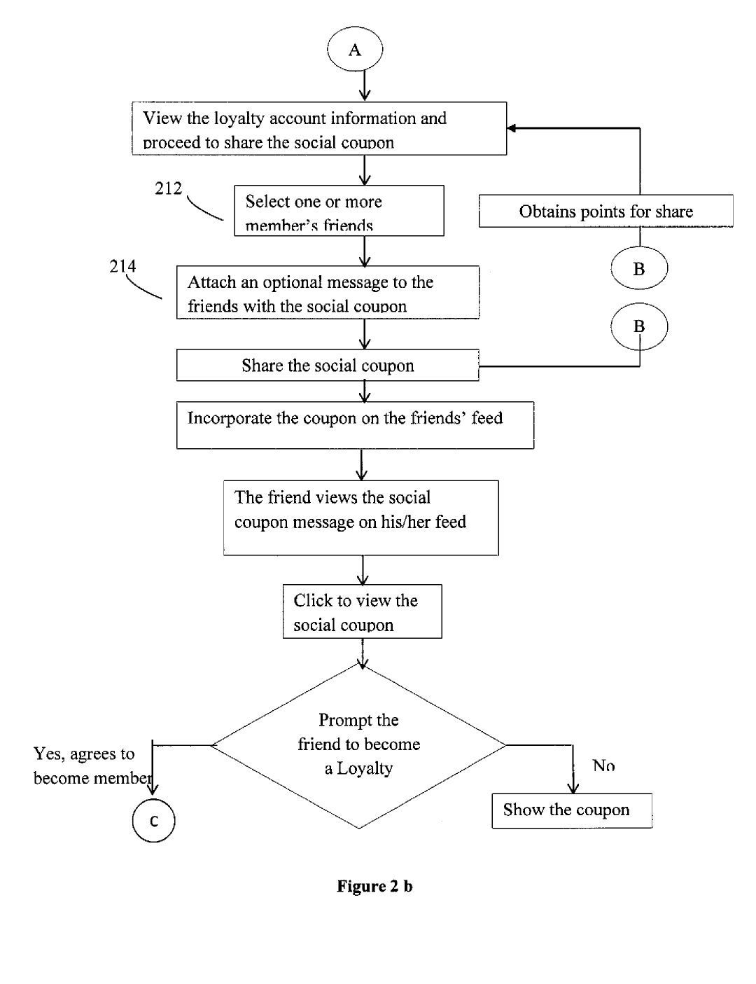

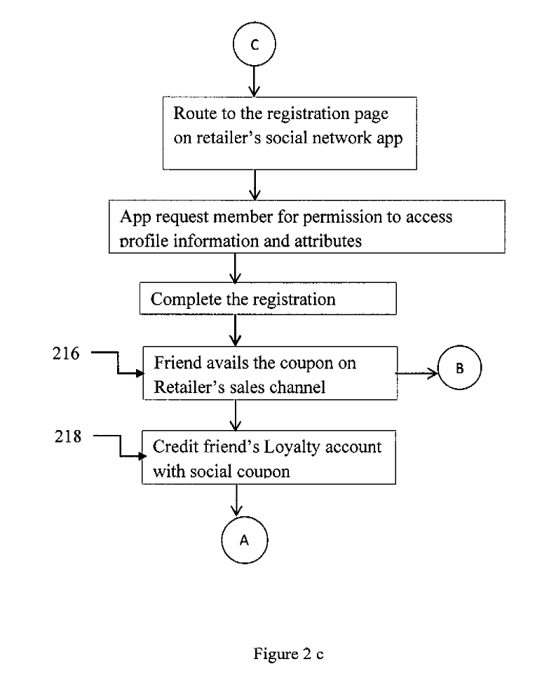

Now referring to FIG. 2a and FIG. 2b, the flow of the social coupon management is illustrated. Step 202 elaborates interaction of the customer 101 with the retailer. The interaction that a loyalty member performs can be both transactional or a non-transactional activity. Here the loyalty member may interact with any person who has enrolled in a loyalty program. A loyalty member may also be any person who is an identifiable customer by a retailer or a customer who has a unique profile maintained with the retailer. Such loyalty members can then access their profiles at any available retailer interaction channels such as Customer Portal, Retail Touch Point, Kiosk, IVR, Web store, Mobile Store, Social Media and the like.

Transaction refers to a purchase, a customer 101 makes with the retailer through any sales channel including web, store, social media, mail, order and the like. Non transactional activity may include any identifiable behavior such as Store check in, ‘nth’ time store visit, login to the web portal, web site, social media sites, profile update, friend referral, perform a retailer initiated activity at the store, web such as surveys, sweepstakes, or a social interaction such as tweet on twitter, like or share on Facebook and the like activities on other social networking platforms.

An interaction may also be triggered because of member's event triggers such as anniversary, birthday, nth year completion of enrolling the loyalty program etc. The interaction may also include behavior exhibited by the member such as tier movement (shift from Silver tier to Gold tier etc or vice versa), reaching a threshold level of points (ex. Accumulated 1000 points, redeemed 1000 points, expired 500 points or a combination of the same), enrollment to a loyalty scheme, repeated purchase of a particular product or products belonging to a category or brand. Hence, interaction can be any identifiable action and behavior exhibited with a retailer and not limited to transaction alone.

Step 204 illustrates crediting a social coupon that may be availed at any sales channel of the retailer, and includes a Bill Value Discount, Bill Value Percentage, Dollar Off, Percentage Off, Bundled offer, Additional loyalty points accumulation offer, Time based offer, Location based offer, Channel specific offer viz. Mobile only, Web only, cumulative offer and the like.

The customer can access a credited social coupon via the social networking platform. Step 208 and 210 elaborates authentication procedures involved in accessing the social coupon 103. The authentication includes onetime permission to grant access to various social attributes of the member. An indicative list may include but is not limited to social contacts' list, news feed data, age, gender, location and the like. Member identification credentials can take many security token mechanisms.

In another aspect of the invention, authentication can be done via identifiers used for identification and can vary based on the loyalty program under definition. Say, for a card based loyalty program, card number with an optional password can be used for the identifiers. Another way can be to use a unique member ID and an optional password. Yet another way can be to use Social Networking website credentials for identification, or any other parameters that are known in the art.

Post authentication the customer can view this social coupon and can share it with networked social contacts. According to FIG. 2b, a primary participating user can select social contacts to whom the coupon can be revealed, or by sharing the coupon 103 with member created or custom groups available in the Social Networking platform 104. This promotes customer's engagement with the retail store, and the customer is the one who propagates promotion rather than the retailer. In yet another embodiment, the Social coupon 103 can be globally published on a social contact's account through the retailer's app. Along with the coupon information; any additional information ranging from simple text to rich media supported by social network may be appended as a message (214).

Once the social coupons are shared, it can be downloaded by the loyalty member's social contacts. FIG. 2c represents the social contact of the loyalty member who downloads the social coupon. It should be noted that a download may refer to physical download of a coupon such as storing the coupon either in a paper-based or paperless format. Also, download of a coupon may refer to the coupon being associated with one's loyalty account. That is, the coupon would then get automatically saved in Loyalty Account. This downloaded social coupon can be availed by the customer's social contact by visiting the retailer's channel for further interaction which leads to increasing the sales of the retailer as shown in step 216. Post availing the coupon, step 218 elaborates on crediting points to the social contact's Loyalty account.

Thus, it can be seen that when a social contact consumes a coupon at a retailer, said social contact can opt to be a loyalty member with that retailer. The social contact may be awarded social coupons based on any transactional activity with the retailer in the near future, and said coupons can be further shared with additional social contacts, thus making the process repeatable, leading to an exponential increase in customer base for a retailer.

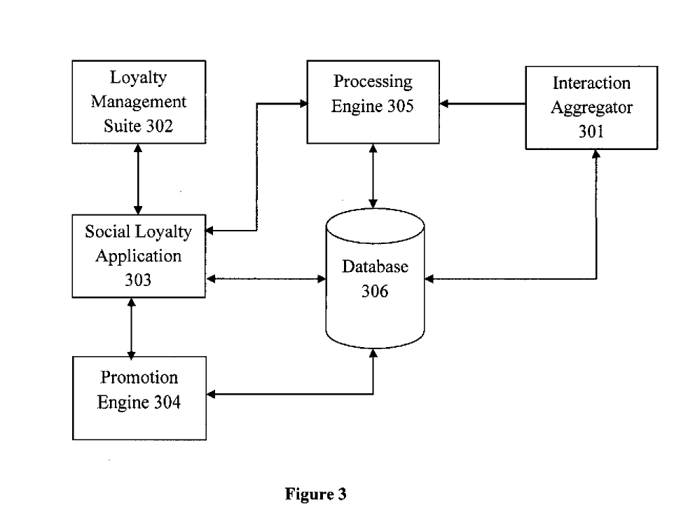

FIG. 3 illustrates the system for implementing the Social coupon and managing its viral nature. Broadly, the system comprises of an interaction aggregator 301, loyalty management suite 302, social loyalty application 303, promotion engine 304, processing engine 305 and a database 306.

The Enrollment module maintains a database of participating users. The said module keeps track of all the social contacts within a participating primary user's social network. It captures the member related information, loyalty account information and point balance information.

Loyalty Management Suite is a back end suite that manages a customer program or a loyalty program including program definition with a predefined set of rules according to the methods described above.

Interaction Aggregator 301 accumulates all transactions and non-transactional activities recorded across various channels and systems for a retailer. The aggregator captures the points credit/debit done due to every interaction done by any member and accordingly maintains the offer templates and its statuses. All such interactions are stored in a database for future reference and to generate metrics that are of relevance to the retailer. For instance, success of a particular event, increase in promotional activity, consumer behavior and so on are some of the metrics that could be tracked and analyzed.

Social Loyalty application enables a member to view and manage loyalty accounts that are integrated within a social networking site. It captures the coupon related information along with an identifier that gets translated to unique code or bar code or QR code and the like on the social network.

Promotion engine 305 obtains data from database (306) to process and deliver promotions or coupons based on the rules defined in the loyalty program to participating users. Through the social loyalty application, a member user can view and share social coupons. Coupon share, download of coupons, redemption of coupons are also treated as interactions and are recorded.

Processing Engine 305 works on the interactions and generates the points occurred for every interaction. The count of social contacts that have downloaded or redeemed every social coupon shared by the customer is also maintained. Every change in the points balance due to accumulation or redemption is synchronized across loyalty application suite and social loyalty application.

We claim:

1. A computer implemented method for facilitating a mechanism to earn loyalty points by utilizing a social networking platform, said method comprising:
crediting one or more social coupons to a corresponding loyalty account of a participating primary user via a processing engine, said loyalty account being maintained for the each participating primary user on a loyalty application embedded within the social networking platform;
facilitating sharing of the social coupon by the participating primary user with social contacts through a plurality of channels on the social platform accrediting the participating primary user with at least one of a share of loyalty points in the loyalty account and a plurality of redeemable social coupons whenever a social contact associated with said participating primary user consumes a social coupon shared; and
rewarding the social contact with at least another social coupon and loyalty points on interacting with the retailer further to consumption of the redeemable social coupon.

2. The method of claim 1, further enabling the social contact to operate as the participating primary user for further sharing the another credited social coupon via the social networking platform.

3. The method of claim 1, wherein the participating primary user accredited with said social coupons, and social contacts intent on consuming said social coupons are enabled to redeem the social coupon awarded by the retailer.

4. The method of claim 1, wherein the interaction is either transactional or non-transactional type or a combination thereof, wherein:
transactional interaction type comprises any activity, or a combination of at least one of a web store, mobile store, physical outlet, kiosk, social media, and mail order; and
non-transactional interaction refers to any identifiable behavior comprising at least one of retailer store check in, number of store visits, login activity to the web portal, web site, social media sites, profile update, social contact referral, completion of a retailer initiated activity, response to surveys, sharing feedback, tracking consumption patterns further comprising tier movement, accumulating threshold level of loyalty points, enrollment to a loyalty scheme, and repeated purchases of products belonging to a category.

5. The method of claim 1, wherein the social coupon comprises a bill value discount, bill value percentage, bundled offers, additional loyalty points accumulation offer, time based offer, location based offer, and channel specific offer.

6. The method of claim 1, further enabling procurement of social coupons between social contacts wherein the procurement is facilitated through exchange of at least one of loyalty points and social interaction points for said social coupons.

7. The method of claim 6 wherein, the social interaction points comprising at least one of game points and points awarded for activities on a social network are redeemed for social coupons awarded by the retailer.

8. A computer implemented system for facilitating a mechanism to earn loyalty points by utilizing a social networking platform, the system comprising:
a computer having memory and a processing engine, and configured to interface with a plurality of remotely positioned participating users, adapted to be in communication with, an enrollment module to generate a database of the participating users;
interaction aggregator implemented upon the processing engine, and configured to store transactional and non-transactional activities recorded across plurality of channels in the database accessible by the computer; and
a set of instructions stored in the memory of the computer that when executed by the computer causes the computer to perform the operations of:
Crediting one or more social coupons to a corresponding loyalty account of the participating primary user via a processing engine, said loyalty account being maintained for each participating user on a loyalty application embedded within the social networking platform;
facilitating sharing of the social coupon by the participating primary user with social contacts through a plurality of channels on the social platform;
accrediting the participating primary user with at least one of a share of loyalty points in the loyalty account and a plurality of redeemable social coupons whenever a social contact associated with said participating primary user consumes a social coupon shared; and
rewarding the social contact with at least another social coupon and loyalty points on interacting with the retailer further to consumption of the redeemable social coupon.

9. The system of claim 8, further comprising a promotion engine to process and deliver the coupons, to enable the primary user redeem the said coupons by the participating primary user accredited with said social coupons, and social contacts intent on consuming said social coupons.

10. The system of claim 8, wherein the interaction is either transactional or non-transactional type or a combination thereof, wherein:
transactional interaction type comprises any activity, or a combination of at least one of a web store, mobile store, physical outlet, kiosk, social media, and mail order; and
non-transactional interaction refers to any identifiable behavior comprising at least one of retailer store check in, number of store visits, login activity to the web portal, web site, social media sites, profile update, social contact referral, completion of a retailer initiated activity, response to surveys, sharing feedback, tracking consumption patterns further comprising tier movement, accumulating threshold level of loyalty points, enrollment to a loyalty scheme, and repeated purchases of products belonging to a category.

11. The system of claim 8, wherein the processing engine works collaboratively with the other modules and generates the points occurred for every interaction.

12. A computer program product comprising at least one non transitory computer-readable medium having computer program instructions tangibly embodied thereon, wherein the computer program instructions are executable by at least one computer processor to perform a method comprising:
crediting one or more social coupons to a corresponding loyalty account of a participating primary user via a processing engine, said loyalty account being maintained for the each participating primary user on a loyalty application embedded within the social networking platform;
facilitating sharing of the social coupon by the participating primary user with social contacts through a plurality of channels on the social platform;
accrediting the participating primary user with at least one of a share of loyalty points in the loyalty account and a plurality of redeemable social coupons whenever a social contact associated with said participating primary user consumes a social coupon shared; and
rewarding the social contact with at least another social coupon and loyalty points on interacting with the retailer further to consumption of the redeemable social coupon.
